(19) United States
(12) Patent Application Publication
(10) Pub. No.: US 2025/0284883 A1
(43) Pub. Date: Sep. 11, 2025

(54) INFORMATION PROCESSING DEVICE, INFORMATION PROCESSING METHOD, AND RECORDING MEDIUM

(71) Applicant: NEC Corporation, Toyota (JP)

(72) Inventors: Satoshi ASHIHARA, Tokyo (JP); Masato Kawasaki, Tokyo (JP)

(73) Assignee: NEC Corporation, Tokyo (JP)

(21) Appl. No.: 19/053,712

(22) Filed: Feb. 14, 2025

(30) Foreign Application Priority Data
Mar. 5, 2024 (JP) 2024-032930
Oct. 7, 2024 (JP) 2024-110677

(51) Int. Cl. G06F 40/186; G06F 16/3329

(52) U.S. Cl. CPC G06F 40/186; G06F 16/33295

(57) ABSTRACT

In the information processing device, the selection means selects a template corresponding to a selected question item from a plurality of question items relating to a business, from a plurality of templates each indicating an instruction text for a document generation model. The generation means generates an instruction text in which answers to the plurality of question items are input in the selected template. The displaying means displays a reply to the generated instruction text from the document generation model.

### TECHNICAL FIELD

This disclosure relates to a technology for a document generation.

### BACKGROUND ART

A technology has been known to generate documents such as brochures and catalogs according to concepts desired by a business operator. For instance, Patent Document 1 describes a document generation system capable of generating documents with its own concept for each store or office.

### PRECEDING TECHNICAL REFERENCES

### Patent Document

Patent Document 1: Japanese Laid-open Patent Publication No. 2006-293428

### SUMMARY

### Problem to Be Solved

However, even with a method in Patent Document 1, it is not always possible to flexibly generate an appropriate document for the business operator.

One object of the present disclosure is to provide an information processing device capable of supporting branding of the business operator.

### Means for Solving the Problem

According to an example aspect of the present invention, there is provided an information processing device including:
at least one memory configured to store instructions; and
at least one processor configured to execute the instructions to:
select a template corresponding to a selected question item from a plurality of question items relating to a business, from a plurality of templates each indicating an instruction text for a document generation model;
generate an instruction text in which answers to the plurality of question items are input in the selected template; and
display a reply to the generated instruction text from the document generation model.

According to another example aspect of the present invention, there is provided an information processing method performed by a computer, the information processing method including:
selecting a template corresponding to a selected question item from a plurality of question items relating to a business, from a plurality of templates each indicating an instruction text for a document generation model;
generating an instruction text in which answers to the plurality of question items are input in the selected template; and
displaying a reply to the generated instruction text from the document generation model.

According to still another example aspect of the present invention, there is provided a non-transitory computer-readable recording medium storing a program causing a computer to execute processing of:
selecting a template corresponding to a selected question item from a plurality of question items relating to a business, from a plurality of templates each indicating an instruction text for a document generation model;
generating an instruction text in which answers to the plurality of question items are input in the selected template; and
displaying a reply to the generated instruction text from the document generation model.

### EFFECT

According to the present disclosure, it is possible to provide an information processing device capable of supporting branding of a business operator.

### BRIEF DESCRIPTION OF THE DRAWINGS

FIG. 1 is a diagram illustrating an overall configuration of a document generation system according to the present disclosure.

FIG. 2 is a block diagram illustrating a hardware configuration of an information processing device according to the present disclosure.

FIG. 3 is a block diagram illustrating a functional configuration of the information processing device according to the present disclosure.

FIGS. 4A and 4B illustrate examples of input screens.

FIG. 5 illustrates an example of a syntax table.

FIG. 6 illustrates an example of a syntax.

FIG. 7 illustrates an example of instruction text.

FIG. 8 is a flowchart of a brand story generation process.

FIG. 9 is a diagram for explaining a modification 1.

FIG. 10 is a diagram for explaining a modification 2.

FIG. 11 is a block diagram illustrating a functional configuration of another information processing device according to the present disclosure.

FIGS. 12A and 12B illustrate examples of menu screens.

FIG. 13 illustrates an example of an image preparation table.

FIGS. 14A and 14B illustrate examples of a question text and an answer text.

FIG. 15 illustrates another example of the syntax.

FIGS. 16A and 16B illustrate examples of an instruction text and a reply by a generative AI.

FIG. 17 is a flowchart of an image generation process.

FIG. 18 illustrates an example of a hashtag preparation table.

FIGS. 19A and 19B illustrates other examples of the question text and the answer text.

FIG. 20 illustrates another example of the syntax.

FIGS. 21A and 21B illustrate other examples of the instruction text and the reply by the generative AI.

FIG. 22 is a flowchart of a hashtag generation process.

FIG. 23 is a block diagram illustrating a functional configuration of another information processing device according to the present disclosure.

FIG. 24 is a flowchart of a process by another information processing device according to the present disclosure.

### EXAMPLE EMBODIMENTS

Preferred example embodiments of the present disclosure will be described with reference to the accompanying drawings.

### First Example Embodiment

### Overall Configuration

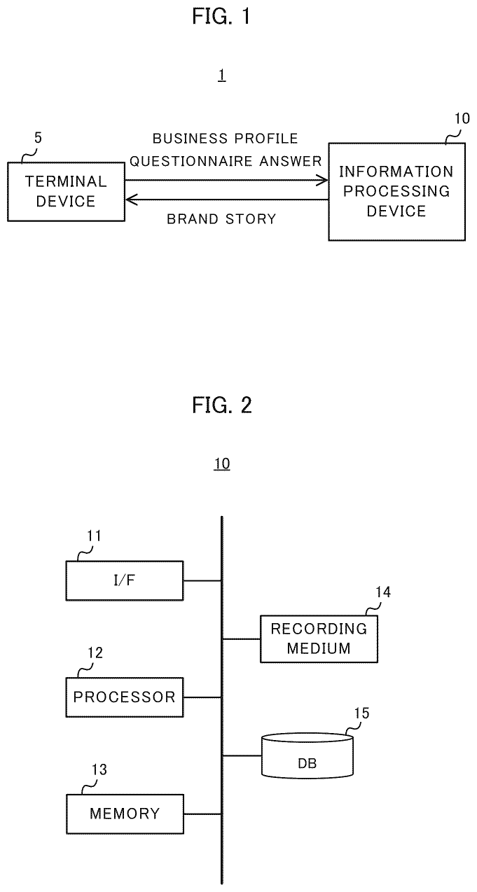

FIG. 1 shows an overall configuration of a document generation system to which an information processing device according to the present disclosure is applied. The document generation system 1 includes a terminal device 5 and an information processing device 10. The terminal device 5 and the information processing device 10 can communicate via wired or wireless connections. Incidentally, a plurality of terminal devices 5 may be included in the document generation system 1.

The terminal device 5 is operated by a person in charge (hereinafter, also referred to as a “user”) of the business operator (a company, etc.) and is used to transmit a document generation request to the information processing device 10. For example, the terminal device 5 transmits a generation request including a profile of the business operator inputted by the user (hereinafter, also referred to as “business profile”) and an answer of a questionnaire (hereinafter, also referred to as “questionnaire answer”) to the information processing device 10. The terminal device 5 is formed, for instance, by a personal computer or a tablet terminal.

The information processing device 10 generates a document based on a request of the terminal device 5 and outputs the document to the terminal device 5. The information processing device 10 of this example embodiment generates a brand story of the business operator as the document. The brand story is a story to convey a brand value of the business operator to consumers.

Specifically, the information processing device 10 generates the brand story using a generative AI (Artificial Intelligence). At this time, the information processing device 10 uses the instruction text generated based on the business operator profile and the questionnaire answer as an input to the generative AI. Thus, the information processing device 10 can generate an appropriate brand story for the business operator and can support the branding of the business operator.

### Hardware Configuration

FIG. 2 is a block diagram illustrating a hardware configuration of the information processing device 10 according to a first example embodiment. As shown, the information processing device 10 includes an interface (I/F) 11, a processor 12, a memory 13, a recording medium 14, and a data base (DB) 15.

The I/F 11 transmits and receives data with an external device. Specifically, The I/F 11 receives information such as business profiles and questionnaire answers from the terminal device 5. The I/F 11 transmits the brand story generated by the information processing device 10 to the terminal device 5.

The processor 12 is a computer such as a CPU (Central Processing Unit) and controls the entire information processing device 10 by executing programs prepared in advance. The processor 12 may be a GPU (Graphics Processing Unit), a DSP (Digital Signal Processor), an MPU (Micro Processing Unit), an FPU (Floating Point number Processing Unit), a PPU (Physics Processing Unit), a TPU (Tensor Processing

Unit), a quantum processor, a microcontroller, or a combination thereof. The processor 12 performs a brand story generation process, which will be described later.

The memory 13 is formed by a ROM (Read Only Memory), a RAM (Random Access Memory), etc. The memory 13 is also used as a working memory during executions of various processes by the processor 12.

The recording medium 14 is a non-volatile and non-transitory recording medium such as a disc-shaped recording medium or a semiconductor memory and is formed to be detachable from the information processing device 10. The recording medium 14 records various programs executed by the processor 12. In a case where the information processing device 10 executes various kinds of processes, the programs recorded on the recording medium 14 are loaded into the memory 13 and executed by the processor 12.

The DB 15 stores data used by the information processing device 10 to generate the brand story. For example, the DB 15 stores the syntax table, which will be described later. In addition, the DB 15 stores information such as business profiles input through the I/F 11.

In addition to the above, the information processing device 10 may include a display device such as a liquid crystal display or a projector, and an input device such as a keyboard or a mouse. The display device and input device, for instance, are used by a manager of the information processing device 10 to perform the necessary management.

### Functional Configuration

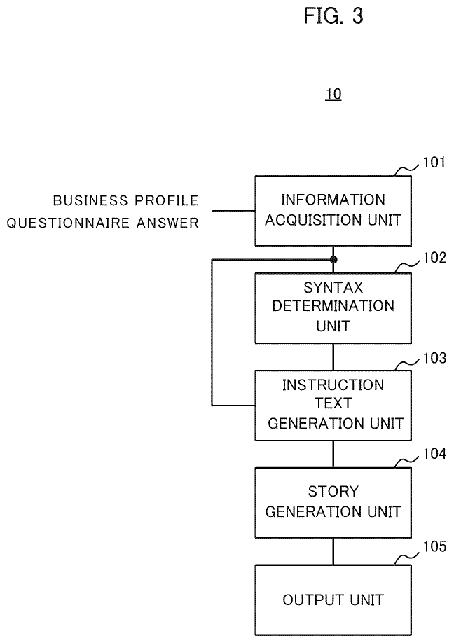

FIG. 3 is a block diagram showing a functional configuration of the information processing device 10 according to the first example embodiment. The information processing device 10 functionally includes an information acquisition unit 101, a syntax determination unit 102, an instruction text generation unit 103, a story generation unit 104, and an output unit 105.

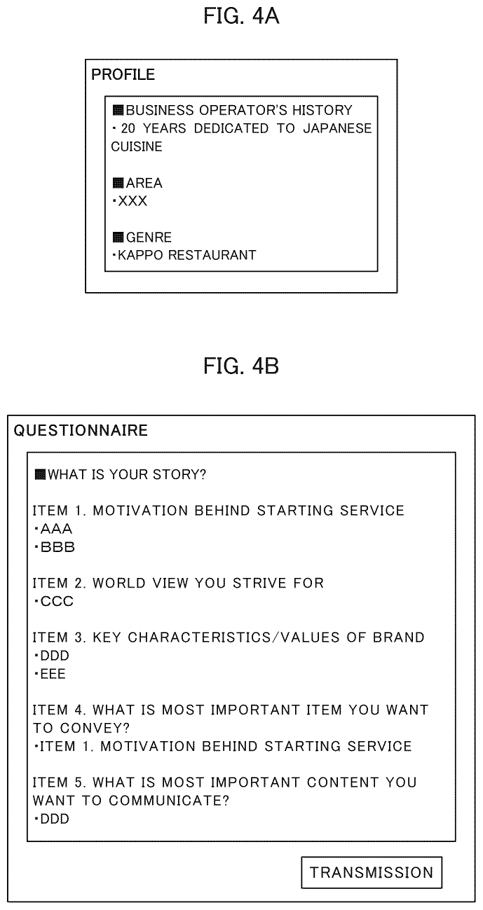

First, the user operates the terminal device 5, inputs the business profile and the questionnaire answer to an input screen as illustrated in FIGS. 4A and 4B. Then, the terminal device 5 transmits the business profile and the questionnaire answer to the information processing device 10.

FIG. 4A shows an example of the input screen of the business profile. The business profile is entered when the document generation system is registered for use. The business profile can also be changed as appropriate, depending on the user's operation. As input items of the profile, FIG. 4A includes “Business operator's history,” “Area,” and “Genre.” For example, the “Business operator's history” includes information such as business activities and years in business. The “Area” includes a business operator's location. The “Genre” includes an industry and a business type. The input items of the profile are examples, and the input items are not limited thereto.

FIG. 4B shows an example of the input screen of the questionnaire. The questionnaire is entered when requesting the document generation. In FIG. 4B, the input items of the questionnaire include an item 1 (Motivation behind starting the service), an item 2 (World view you strive for), an item 3 (Key characteristics/values of the brand), an item 4 (What is a most important item you want to convey?) and an item 5 (What is a most important content you want to communicate?). Incidentally, the item 4 is selected by the user from among the items 1 to 3. In addition, the item 5 is selected by the user from among the contents described in the items 1 to 3. The input items of the questionnaire are examples, and the input items are not limited thereto.

Referring back to FIG. 3, the information acquisition unit 101 acquires the business profile and the questionnaire answer from the terminal device 5. Then, the information acquisition unit 101 outputs the business profile and the questionnaire answer to the syntax determination unit 102 and the instruction text generation unit 103.

The syntax determination unit 102 selects a syntax used to generate the instruction text from among a plurality of syntaxes stored in the DB 15. The syntax is a template of the instruction text. For instance, the DB 15 stores a syntax table, which associates the answer to a certain item in the questionnaire with the syntax. The syntax determination unit 102 refers to the syntax table and selects the syntax corresponding to the answer of the certain item among the questionnaire answers input from the information acquisition unit 101 as the syntax for generating the instruction text.

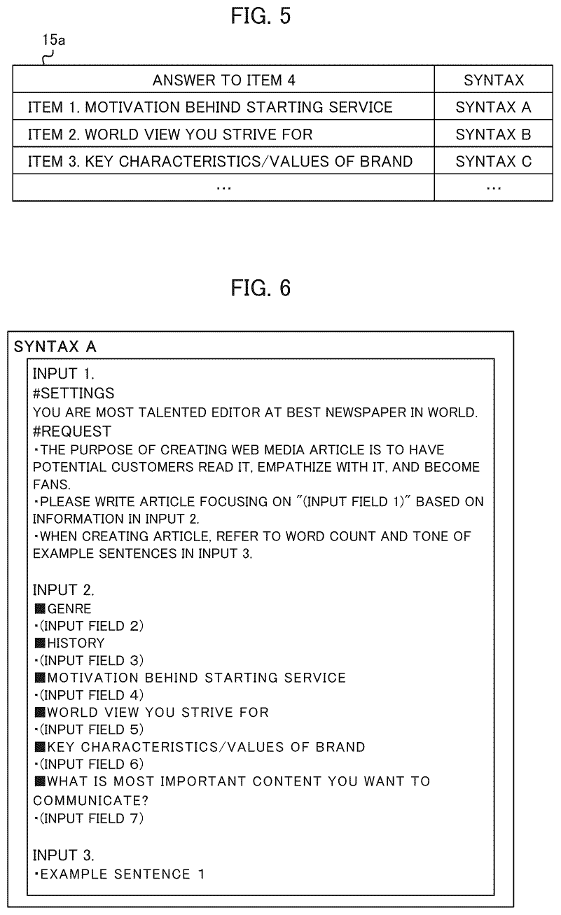

FIG. 5 shows an example of the syntax table stored in the DB 15. In the syntax table 15a of FIG. 5, for each answer to the item 4 (what is the most important item you want to convey?) of the questionnaire of FIG. 4B, the corresponding syntax (syntaxes A to C) for each answer is stored. For example, if the user selects the item 1 (the motivation behind starting the service) as the answer to the item 4, the syntax determination unit 102 selects the syntax A. When the user selects the item 2 (the world view you strive for) as the answer to the item 4, the syntax determination unit 102 selects the syntax B. In addition, when the user selects the item 3 (Key characteristics/values of the brand) as the answer to item 4, the syntax determination unit 102 selects the syntax C. The above syntax table is an example, and the syntax table is not limited thereto. For example, the syntax determination unit 102 may select the syntax from the questionnaire answer by referring to the syntax table, which associates the answers of other items in the questionnaire with the syntaxes.

Referring back to FIG. 3, the syntax determination unit 102 outputs the selected syntax to the instruction text generation unit 103.

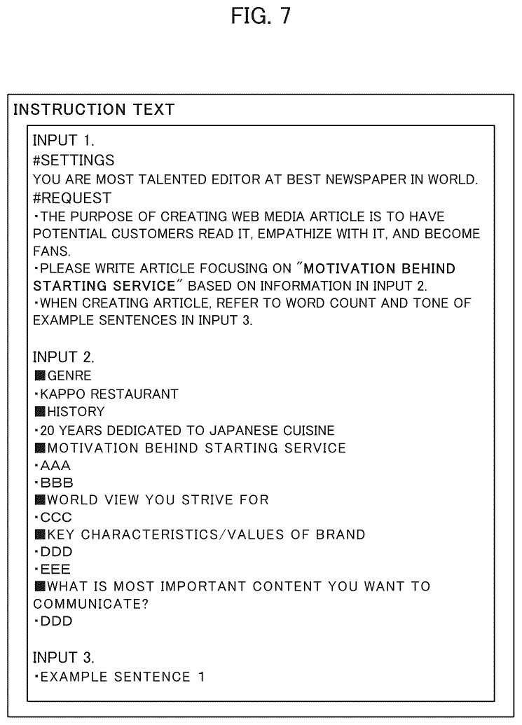

The instruction text generation unit 103 generates an instruction text by inputting the business profile and the questionnaire answer to a corresponding input portions of the syntax. For example, the instruction text generation unit 103 generates the instruction text as illustrated in FIG. 7 by inputting the business profile and the questionnaire answer into input fields of the syntax illustrated in FIG. 6. Specifically, the syntax illustrated in FIG. 6 includes a plurality of input fields (input fields 1 to 7), and the instruction text generation unit 103 generates the instruction text as illustrated in FIG. 7 by inputting the answer of the item 4 of the questionnaire in the input field 1, inputting the genre and the history of the business profile in the input fields 2 to 3, and inputting the answer of the items 1 to 3 and 5 of the questionnaire in the input fields 4 to 7, respectively.

The instruction text generation unit 103 outputs the generated instruction text to the story generation unit 104.

The story generation unit 104 inputs the instruction text into a generative AI and acquires the brand story as a reply to the instruction text from the generative AI. The story generation unit 104 uses, for instance, a large language model (LLM) as the generative AI. The LLM is a natural language processing model trained on a large amount of text data to learn relationships between words within sentences. The LLM generates a related string associated with a target string from the target string which has been input. For instance, ChatGPT by OpenAI, etc. is considered as the LLM.

The story generation unit 104 outputs the brand story to the output unit 105. The output unit 105 transmits the brand story to the terminal device 5.

In the configuration described above, the information acquisition unit 101 and the syntax determination unit 102 correspond to an example of a selection means, the instruction text generation unit 103 corresponds to an example of generation means, the story generation unit 104 and the output unit 105 correspond to an example of a displaying means.

### Brand Story Generation Process

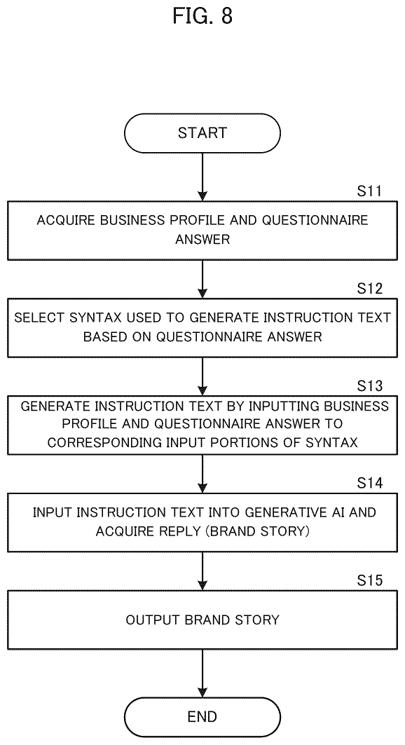

Next, the brand story generation process will be described. FIG. 8 is a flowchart of the brand story generation process by the information processing device 10. This process is realized by the processor 12 shown in FIG. 2 executing a program prepared in advance and operating as each element shown in FIG. 3.

First, the information acquisition unit 101 acquires the business profile and the questionnaire answer from the terminal device 5 (step S11). The information acquisition unit 101 outputs the business profile and the questionnaire answer to the syntax determination unit 102 and the instruction text generation unit 103.

Next, the syntax determination unit 102 selects the syntax used to generate the instruction text from among the plurality of syntaxes stored in the DB 15 (step S12). The syntax determination unit 102 refers to the syntax table and selects the syntax corresponding to the answer of the certain item among the questionnaire answers input from the information acquisition unit 101 as the syntax for generating the instruction text. The syntax determination unit 102 outputs the selected syntax to the instruction text generation unit 103.

Next, the instruction text generation unit 103 generates the instruction text by inputting the business profile and the questionnaire answer to the corresponding input portions of the syntax (step S13). The instruction text generation unit 103 outputs the generated instruction text to the story generation unit 104.

Next, the story generation unit 104 inputs the instruction text into the generative AI and acquires the brand story as the reply to the instruction text from the generative AI (step S14). The story generation unit 104 outputs the brand story to the output unit 105. Next, the output unit 105 transmits the brand story to the terminal device 5 (step S15). After that, the process is terminated.

### Modification

Next, modifications of the first example embodiment will be described. The following modifications can be applied to the first example embodiment.

### Modification 1

The information processing device 10 may generate a plurality of brand stories based on the business profile and the questionnaire answer, and transmit the plurality of brand stories to the terminal device 5. For example, the information processing device 10 may generate the plurality of brand stories by adding instructions such as “Please generate three brand stories” to the instruction text thereby prompting the generative AI to generate the plurality of brand stories.

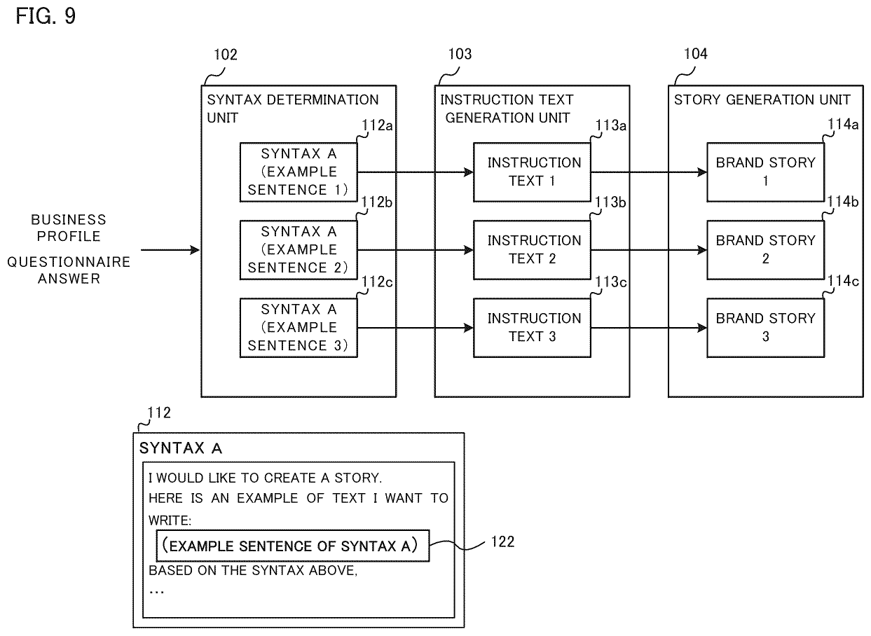

The information processing device 10 may input a plurality of instruction texts into the generative AI, thereby prompting the generative AI to generate the plurality of brand stories. For example, the information processing device 10 generates the plurality of brand stories by inputting the plurality of instruction texts, each generated from the plurality of syntaxes with different content, into the generative AI. FIG. 9 is a diagram for explaining the modification 1. As illustrated in FIG. 9, the syntax determination unit 102 selects three syntaxes with different content (syntaxes 112a to 112c) based on the questionnaire answer from the user. The syntaxes 112a to 112c are syntaxes in which the content of an example sentence area 122 of the syntax 112 is changed. Incidentally, the example sentence area 122 is an area where the example sentence of the text to be generated by generative AI is input. The instruction text generation unit 103 generates the instruction text 113a to 113c from the syntaxes 112a to 112c, respectively. Then, story generation unit 104 generates brand stories 114a to 114c from the instruction texts 113a to 113c, respectively.

Thus, the information processing device 10 of the modification 1 can present a plurality of brand stories to the user. This allows the user to select a preferred brand story from the plurality of brand stories.

### Modification 2

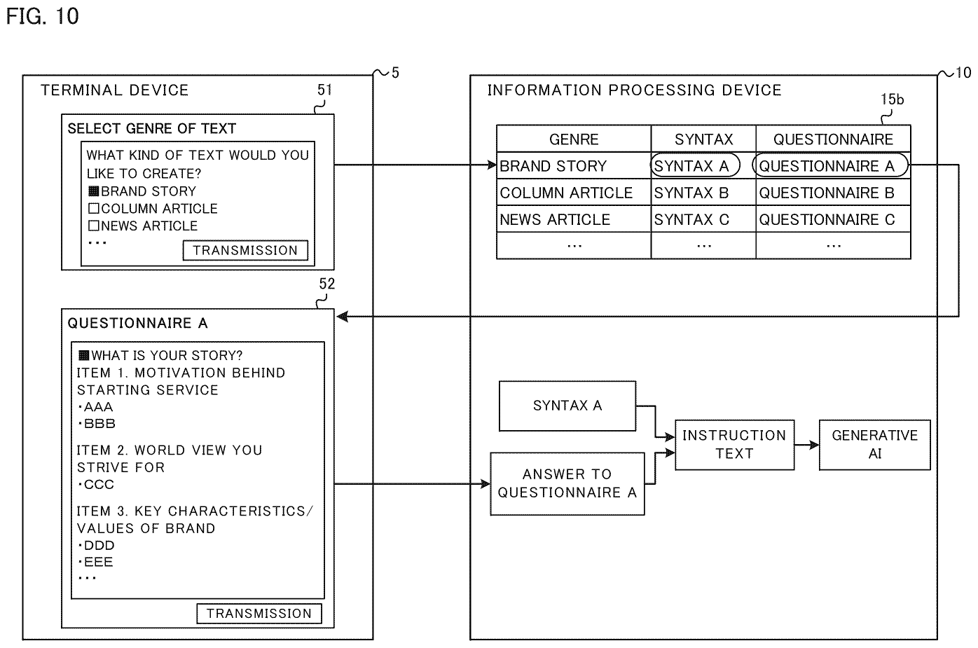

In addition to the brand story, the information processing device 10 may generate texts of other genres such as column articles and news articles. FIG. 10 is a diagram for explaining a modification 2.

For example, the user operates the terminal device 5, and transmits a request to the information processing device 10 for generating a text that includes a desired genre. Specifically, a genre selection screen 51 as illustrated in FIG. 10 is displayed on the terminal device 5. When the user selects the desired genre and presses the transmission button, the terminal device 5 transmits the genre selected by the user to the information processing device 10.

Next, the information processing device 10 transmits the questionnaire to the terminal device 5. Specifically, the information processing device 10 refers to a questionnaire/syntax table 15b and selects a questionnaire corresponding to the genre selected by the user. Then, the information processing device 10 transmits the questionnaire selected to the terminal device 5. The information processing device 10 refers to the questionnaire/syntax table 15b and selects the syntax corresponding to the genre selected by the user. The questionnaire/syntax table 15b is a table that associates the genres, the syntaxes, and the questionnaires, and is stored in the DB 15. In FIG. 10, the genre selected by the user is a “brand story”, and the information processing device 10 refers to the questionnaire/syntax table 15b and selects the questionnaire A and the syntax A corresponding to the brand story.

Next, a questionnaire 52 as illustrated in FIG. 10 is displayed on the terminal device 5. When the user enters the answer to the questionnaire and presses the transmission button, the terminal device 5 transmits the questionnaire answer to the information processing device 10. Next, the information processing device 10 generates the instruction text by inputting the questionnaire answer to the corresponding input portion of the syntax. The information processing device 10 inputs the instruction text into the generative AI and acquires the text of the genre selected by the user as a reply to the instruction text from the generative AI.

### Modification 3

The information processing device 10 may post the brand story on a predetermined Web site or a predetermined SNS (Social Network Service). For example, the user operates the terminal device 5 and transmits a posting request of the brand story to the information processing device 10. When the information processing device 10 receives the posting request from the terminal device 5, it posts the relevant brand story on the predetermined Web site or the predetermined SNS. This allows the user to make the business operator's brand story recognizable to consumers.

According to the first example embodiment and the modifications thereof, it is possible to provide the information processing device capable of supporting branding of the business operator.

### Second Example Embodiment

Next, a second example embodiment will be described. An information processing device 10a of the second example embodiment can create an image and a hashtag in accordance with a content of a brand story. Accordingly, it is possible for a user to easily prepare for publishing on SNS and the web. Note that an overall configuration and a hardware configuration are the same as those of the first example embodiment, and thus, explanations thereof will be omitted.

### Functional Configuration

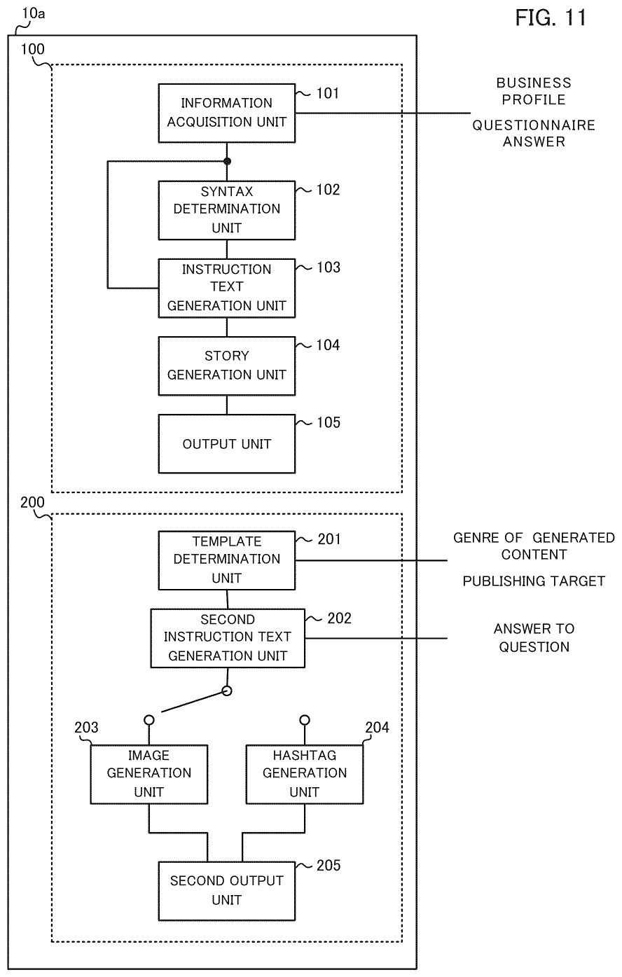

FIG. 11 is a block diagram illustrating a functional configuration of an information processing device 10a according to the second example embodiment. The information processing device 10a functionally includes a text generation unit 100 and an additional element generation unit 200. Since the text generation unit 100 has the same configuration as the information processing device 10 according to the first example embodiment and operates in the same manner, a description thereof will be omitted.

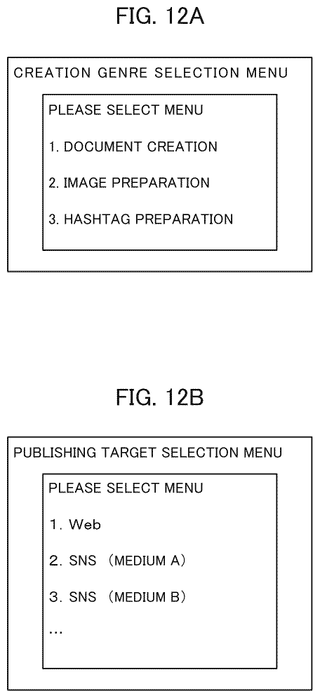

In a case where the user desires to incorporate images or hashtags into a brand story, the user operates the terminal device 5 and transmits a request for creating the images or the hashtags to the information processing device 10a. FIGS. 12A and 12B are examples of a menu screen displayed on the terminal device 5. The user can transmit the request for creating the images or the hashtags to the information processing device 10a by selecting the relevant item from the menu screens of FIG. 12A and 12B.

FIG. 12A is an example of the menu screen for selecting a genre of creation (hereinafter, also referred to as “genre selection menu”). The genre selection menu in FIG. 12A includes “1. Document creation”, “2. Image preparation” and “3. Hashtag preparation” as the selection items. If the user wants to obtain the brand story, the user should select the “1. Document creation”. If the user wants to obtain the images, the user should select the “2. Image preparation”. If the user wants to obtain the hashtags, the user should select the “3. Hashtag preparation”. FIG. 12B is an example of the menu screen (hereinafter, also referred to as “publishing target selection menu”) for selecting a medium to publish the brand story (hereinafter, also referred to as “publishing target”). The publishing target selection menu of FIG. 12B includes “1. Web,” “2. SNS (Medium A)” and “3. SNS (Medium B)” as the selection items. In addition, the publishing target selection menu may be displayed when the “2. Image preparation” or the “3. Hashtag preparation” is selected.

The terminal device 5 transmits the request for creation, including the genre of creation and the publishing target selected by the user, to the information processing device 10a.

Referring back to FIG. 11, the information processing device 10a receives the genre of creation and the publishing target from the terminal device 5. If the genre of creation is the “1. Document creation”, the brand story generation process is executed by the text generation unit 100. On the other hand, if the genre of creation is the “2. Image preparation” or the “3. Hashtag preparation”, the genre of creation and the publishing target are input to the additional element generation unit 200, and the image generation process or the hashtag generation process described later is executed.

The additional element generation unit 200 generates the images and the hashtags related to the brand story. Specifically, the additional element generation unit 200 generates the instruction text for instructing the generation of the images or the hashtags based on the user's request. The additional element generation unit 200 inputs the instruction text into the generative AI and acquires the images and the hashtags related to the brand story.

The additional element generation unit 200 includes a template determination unit 201, a second instruction text generation unit 202, an image generation unit 203, a hashtag generation unit 204, and a second output unit 205.

### (1) Image Generation Process

First, an image generation process will be described. If the genre of creation is the “2. Image preparation,” the additional element generation unit 200 performs the image generation process and generates the images related to the brand story.

The genre of creation and the publishing target received from the terminal device 5 are input to the template determination unit 201. The template determination unit 201 selects a question text and a syntax from the DB 15 based on the genre of creation and the publishing target. The question text is directed at the user, and includes the question items related to the images. Also, the syntax is a template of the instruction text to instruct the generation of the images.

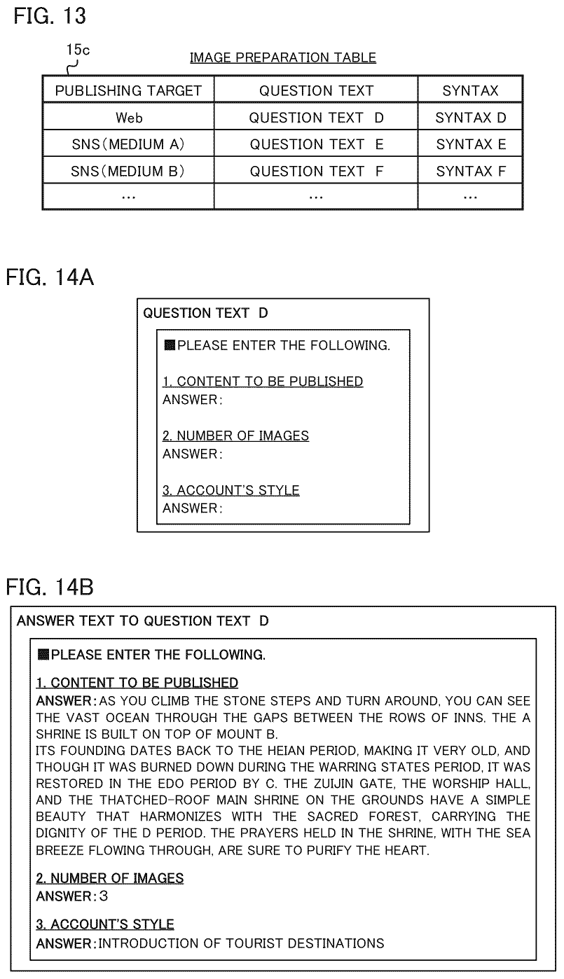

FIG. 13 shows an example of an image preparation table stored in the DB 15. The image preparation table 15c of FIG. 13 is a table that associates the publishing targets, the question texts, and the syntaxes. The template determination unit 201 selects the question text and the syntax from the image preparation table 15c based on the publishing target. For example, if the user selects the “1. Web” as the publishing target, the template determination unit 201 refers to the image preparation table 15c of FIG. 13 and selects the question text D and the syntax D.

Referring back to FIG. 11, the template determination unit 201 transmits the selected question text to the terminal device 5. The template determination unit 201 outputs the selected syntax to the second instruction text generation unit 202.

The user enters the answer to the question text through the terminal device 5 and transmits the answer to the information processing device 10a. The answer to the question text is input to the second instruction text generation unit 202.

FIGS. 14A and 14B show examples of the question text and the answer text. The question text in FIG. 14A includes “1. Content to be published”, “2. Number of images” and “3. Account's style” as question items. The user enters the answer into each question item and creates the answer text as shown in FIG. 14B. Specifically, the user inputs the text (brand story) to be posted on the publishing target in the answer field for the “1. Content to be published” and the number of images to be posted in the answer field for the “2. Number of images.” In addition, the user inputs the account's style used for posting content, such as a corporate account, in the answer field for the “3. Account's style.” The account's style includes, for example, things like the values the account prioritizes and the purpose of managing the account. For example, if the user is posting content on the website introducing tourist destinations, the user would enter “Introduction of tourist destinations” etc. in the “3. Account's style.”

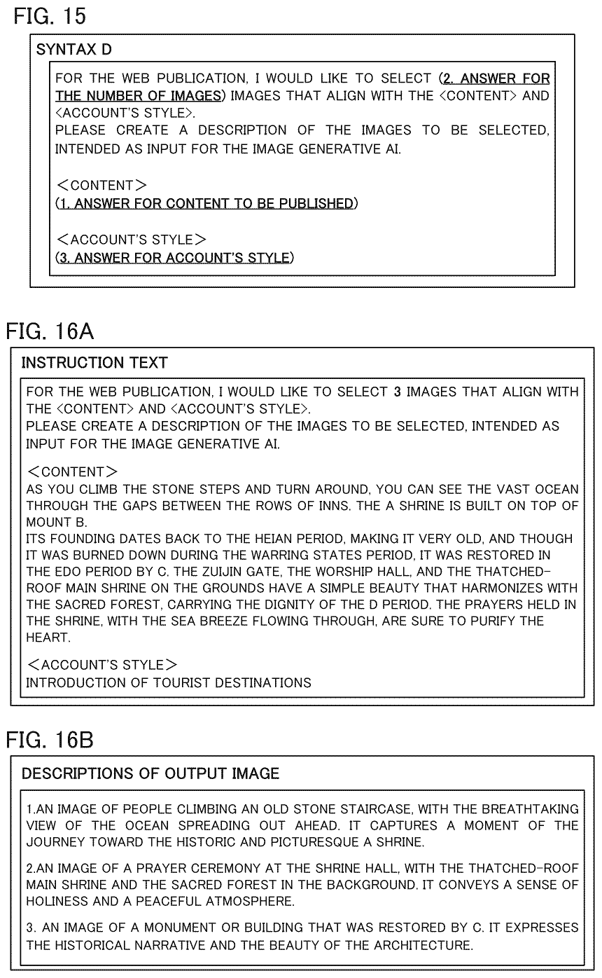

Returning to FIG. 11, the second instruction text generation unit 202 generates the instruction text based on the syntax input from the template determination unit 201 and the answers to the question text. Specifically, the syntax includes one or more input portions, and the second instruction text generation unit 202 generates the instruction text by inputting the user's answers into the corresponding input portions of the syntax. FIG. 15 shows an example of the syntax. The syntax of FIG. 15 includes three input portions: “(1. Answer for the content to be published),” “(2. Answer for the number of images)” and “(3. Answer for the account's style).” The second instruction text generation unit 202 inputs the answer of each question item in FIG. 14B into the corresponding input portion of the syntax, and generates the instruction text as illustrated in FIG. 16A.

The second instruction text generation unit 202 outputs the generated instruction text to the image generation unit 203.

The image generation unit 203 inputs the instruction text into the generative AI and acquires image descriptions as a reply to the instruction text from the generative AI. The image descriptions are texts that indicate what kind of image should be incorporated into the content. For example, the image generation unit 203 inputs the instruction text as illustrated in FIG. 16A into the generative AI and acquires answers (image descriptions) as illustrated in FIG. 16B.

The image generation unit 203 generates images based on the image descriptions. For example, the image generation unit 203 can generate the images using an image generative AI. In this case, the image generation unit 203 inputs the image descriptions as prompts into the image generative AI. Then, the image generation unit 203 acquires the images as a reply from the image generative AI. The image generative AI includes, for example, Stable Diffusion by Stability AI. The image generation unit 203 outputs the images to the second output unit 205. The second output unit 205 transmits the images to the terminal device 5.

The image generation unit 203 may transmit the image descriptions to the terminal device 5 without generating the images. The user can prepare the images related to the brand story by taking photographs or the like according to the image descriptions.

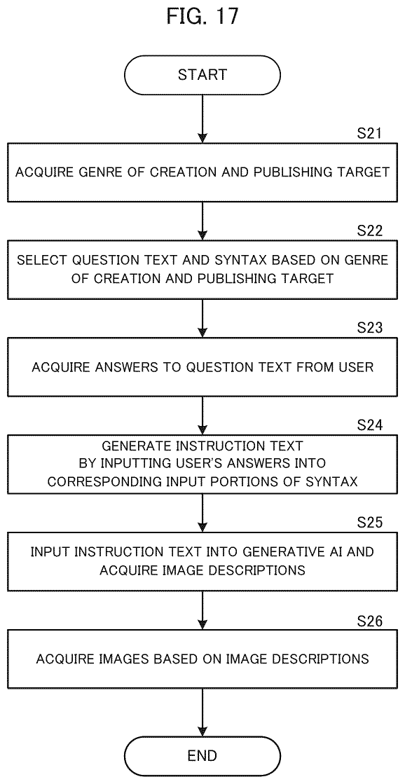

FIG. 17 is a flowchart of the image generation process. This process is realized by the processor 12 shown in FIG. 2 executing a program prepared in advance and operating as each element shown in FIG. 11.

First, the template determination unit 201 acquires the genre of creation and the publishing target from the terminal device 5 (step S21). Next, the template determination unit 201 selects the question text and the syntax from the DB 15 based on the genre of creation and the publishing target (step S22). The template determination unit 201 transmits the selected question text to the terminal device 5. The template determination unit 201 outputs the selected syntax to the second instruction text generation unit 202.

Next, second instruction text generation unit 202 acquires the syntax from the template determination unit 201. The second instruction text generation unit 202 acquires the answer to the question text from the user (step S23). Next, the second instruction text generation unit 202 generates the instruction text by inputting the user's answers into the corresponding input portions of the syntax (step S24). The second instruction text generation unit 202 outputs the generated instruction text to the image generation unit 203.

Next, the image generation unit 203 inputs the instruction text into the generative AI and acquires image descriptions as the reply to the instruction text from the generative AI (step S25). Next, the image generation unit 203 acquires the images based on the image descriptions (step S26). For example, the image generation unit 203 acquires the images by inputting the image descriptions as prompts into the image generative AI. The image generation unit 203 outputs the images to the second output unit 205. The second output unit 205 transmits the images to the terminal device 5. After that, the process is terminated.

### (2) Hashtag Generation Process

Next, a hashtag generation process will be described. If the genre of creation is the “3. Hashtag preparation,” the additional element generation unit 200 performs the hashtag generation process and generates the hashtags related to the brand story.

The genre of creation and the publishing target received from the terminal device 5 are input to the template determination unit 201. The template determination unit 201 selects a question text and a syntax from the DB 15 based on the genre of creation and the publishing target. The question text is directed at the user, and includes the question items related to the hashtags. Also, the syntax is a template of the instruction text to instruct the generation of the hashtags.

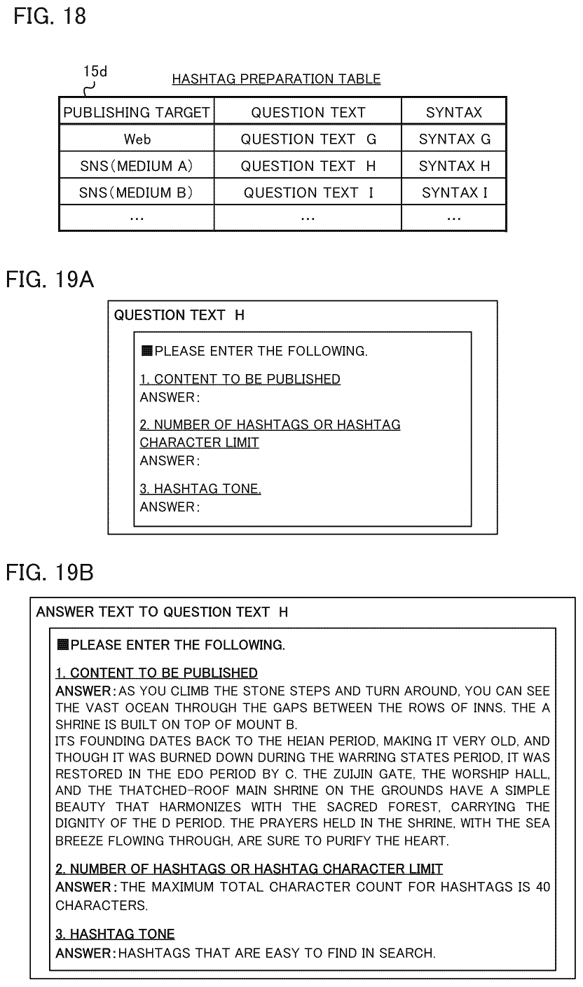

FIG. 18 shows an example of a hashtag preparation table stored in the DB 15. The hashtag preparation table 15d of FIG. 18 is a table that associates the publishing targets, the question texts, and the syntaxes. The template determination unit 201 selects the question text and the syntax from the hashtag preparation table 15d based on the publishing target. For example, if the user selects the “2. SNS (Medium A)” as the publishing target, the template determination unit 201 refers to the hashtag preparation table 15d of FIG. 18 and selects the question text H and the syntax H.

Referring back to FIG. 11, the template determination unit 201 transmits the selected question text to the terminal device 5. The template determination unit 201 outputs the selected syntax to the second instruction text generation unit 202.

The user enters the answer to the question text through the terminal device 5 and transmits the answer to the information processing device 10a. The answer to the question text is input to the second instruction text generation unit 202.

FIGS. 19A and 19B show examples of a question text and an answer text. The question text in FIG. 19A includes “1. Content to be published,” “2. Number of hashtags or hashtag character limit,” 3. Hashtag tone.” The user enters the answer into each question item and creates the answer text as shown in FIG. 19B. Specifically, the user inputs the text (brand story) to be posted on the publishing target in the answer field for the “1. Content to be published” and the number of hashtags or hashtag character limit to be posted in the answer field for the “2. Number of Hashtags or hashtag character limit.” In addition, the user can input in the answer field for the “3. hashtag tone” the types of hashtags the user wants to create, such as “hashtags that are easy to find in search,” “hashtags that attract interest,” or “text-like hashtags.”

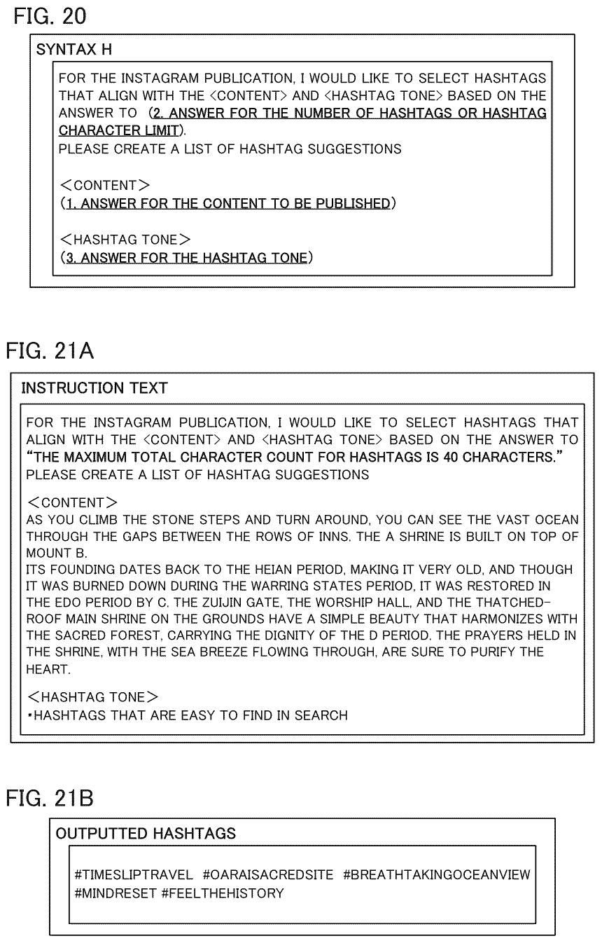

Returning to FIG. 11, the second instruction text generation unit 202 generates the instruction text based on the syntax input from the template determination unit 201 and the answer to the question text. Specifically, the syntax includes one or more input portions, and the second instruction text generation unit 202 generates the instruction text by inputting the user's answers into the corresponding input portions of the syntax. For example, FIG. 20 shows an example of the syntax. The syntax of FIG. 20 includes three input portions: “(1. Answer for the content to be published),” “(2. Answer for the number of hashtags or hashtag character limit)” and “(3. Answer for the hashtag tone).” The second instruction text generation unit 202 inputs the answer of each question item in FIG. 19B into the corresponding input portion of the syntax, and generates the instruction text as illustrated in FIG. 21A.

The second instruction text generation unit 202 outputs the generated instruction text to the hashtag generation unit 204.

The hashtag generation unit 204 inputs the instruction text into the generative AI and acquires the hashtags as a reply to the instruction text from the generative AI. For example, the hashtag generation unit 204 inputs the instruction text as illustrated in FIG. 21A into the generative AI and acquires the reply (hashtags) as illustrated in FIG. 21B. The hashtag generation unit 204 outputs the hashtags to the second output unit 205. The second output unit 205 transmits the hashtags to the terminal device 5.

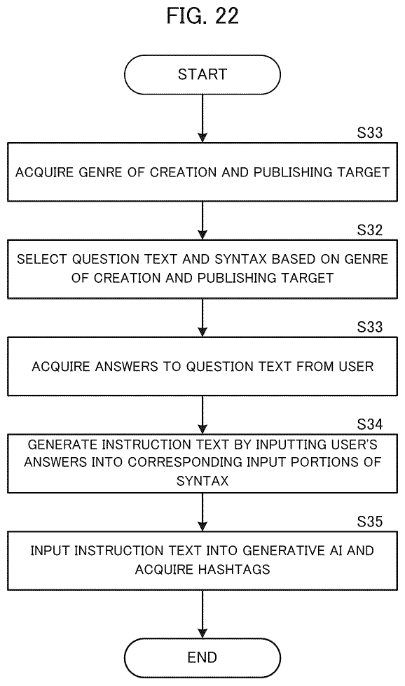

FIG. 22 is a flowchart of the hashtag generation process. This process is realized by the processor 12 shown in FIG. 2 executing a program prepared in advance and operating as each element shown in FIG. 11. Since the process from steps S31 to S34 is the same as the process from steps S21 to S24 of the flowchart of the image generation process illustrated in FIG. 17, the explanation will be omitted.

The instruction text obtained in step S34 is outputted to the hashtag generation unit 204. The hashtag generation unit 204 inputs the instruction text into the generative AI and acquires the hashtags as a reply to the instruction text from the generative AI (step S35). The hashtag generation unit 204 outputs the hashtags to the second output unit 205. The second output unit 205 transmits the hashtags to the terminal device 5. After that, the process is terminated.

According to the information processing device of the second example embodiment, the images or the hashtags related to the brand story can be generated. The user can easily prepare to publish on SNS and the web by incorporating the images or the hashtags into the brand story.

The additional element generation unit 200 corresponds to an example of an additional element generation means.

### Third Example Embodiment

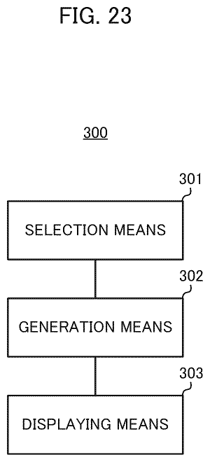

FIG. 23 is a block diagram illustrating a functional configuration of an information processing device according to a third example embodiment. An information processing device 300 includes a selection means 301, a generation means 302, and a displaying means 303.

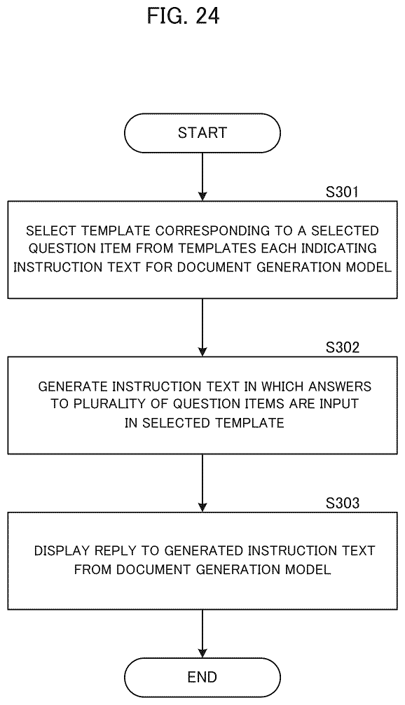

FIG. 24 is a flowchart illustrating process performed by the information processing device according to the third example embodiment. The selection means 301 selects a template corresponding to a selected question item from a plurality of question items relating to a business, from a plurality of templates each indicating an instruction text for a document generation model (step S301). The generation means 302 generates an instruction text in which answers to the plurality of question items are input in the selected template (step S302). The displaying means 303 displays a reply to the generated instruction text from the document generation model (step S303).

According to the information processing device 300 of the third example embodiment, it is possible to support branding of a business operator.

A part or all of the example embodiments described above may also be described as the following supplementary notes, but not limited thereto.

Supplementary note 1

An information processing device comprising:
at least one memory configured to store instructions; and
at least one processor configured to execute the instructions to:
select a template corresponding to a selected question item from a plurality of question items relating to a business, from a plurality of templates each indicating an instruction text for a document generation model;
generate an instruction text in which answers to the plurality of question items are input in the selected template; and
display a reply to the generated instruction text from the document generation model.

### Supplementary Note 2

The information processing device according to Supplementary note 1,
wherein the processor is further configured to store a first table, which associates the answer to a certain question item with the template, and
wherein the processor selects the template based on the answer to the certain question item by referring to the first table.

### Supplementary Note 3

The information processing device according to Supplementary note 1,
wherein the processor is further configured to receive a genre of text to be generated,
wherein the processor selects a question text including the plurality of question items relating to the business and the template based on the genre of text to be generated, and
wherein the processor generates the instruction text in which the answers to the question text are input in the selected template.

### Supplementary Note 4

The information processing device according to Supplementary note 3,
wherein the processor is further configured to store a second table that associates the genre of text to be generated, the question text including the plurality of question items relating to the business, and the template, and
wherein the processor selects the question text and the template corresponding to the genre of text to be generated by referring to the second table.

### Supplementary Note 5

The information processing device according to Supplementary note 1,
wherein the processor selects the plurality of templates with different contents, and
wherein the processor generates the instruction texts in which the answers to the plurality of question items are input in the selected plurality of templates.

### Supplementary Note 6

The information processing device according to Supplementary note 1,
wherein the processor inputs a number of documents to be generated to the instruction text.

### Supplementary Note 7

The information processing device according to Supplementary note 1,
wherein the processor is further configured to publish a reply from the document generation model on internet, and
wherein the processor publishes the reply specified by a business operator on the internet.

### Supplementary Note 8

The information processing device according to Supplementary note 7,
wherein the processor is further configured to generate images or hashtags related to the reply from the document generation model.

### Supplementary Note 9

An information processing method performed by a computer, comprising:
selecting a template corresponding to a selected question item from a plurality of question items relating to a business, from a plurality of templates each indicating an instruction text for a document generation model;
generating an instruction text in which answers to the plurality of question items are input in the selected template; and
displaying a reply to the generated instruction text from the document generation model.

### Supplementary Note 10

A non-transitory computer-readable recording medium storing a program causing a computer to execute processing of:
selecting a template corresponding to a selected question item from a plurality of question items relating to a business, from a plurality of templates each indicating an instruction text for a document generation model;
generating an instruction text in which answers to the plurality of question items are input in the selected template; and
displaying a reply to the generated instruction text from the document generation model.

While the present invention has been described with reference to the example embodiments and examples, the present invention is not limited to the above example embodiments and examples. Various changes which can be understood by those skilled in the art within the scope of the present invention can be made in the configuration and details of the present invention.

This application is based upon and claims the benefit of priority from Japanese Patent Application 2024-032930 filed on Mar. 5, 2024 and 2024-110677 filed on Jul. 10, 2024, the disclosure of which is incorporated herein in its entirety by reference.

### DESCRIPTION OF SYMBOLS

1 Document generation system
5 Terminal device
10 Information processing device
15 Database (DB)
100 Text generation unit
101 Information acquisition unit
102 Syntax determination unit
103 Instruction text generation unit
104 Story generation unit
105 Output unit
200 Additional element generation unit
201 Template determination unit
202 Second instruction text generation unit
203 Image generation unit
204 Hashtag generation unit
205 Second output unit

1. An information processing device comprising:
at least one memory configured to store instructions; and
at least one processor configured to execute the instructions to:
select a template corresponding to a selected question item from a plurality of question items relating to a business, from a plurality of templates each indicating an instruction text for a document generation model;
generate an instruction text in which answers to the plurality of question items are input in the selected template; and
display a reply to the generated instruction text from the document generation model.

2. The information processing device according to claim 1,
wherein the processor is further configured to store a first table, which associates the answer to a certain question item with the template, and
wherein the processor selects the template based on the answer to the certain question item by referring to the first table.

3. The information processing device according to claim 1,
wherein the processor is further configured to receive a genre of text to be generated,
wherein the processor selects a question text including the plurality of question items relating to the business and the template based on the genre of text to be generated, and
wherein the processor generates the instruction text in which the answers to the question text are input in the selected template.

4. The information processing device according to claim 3,
wherein the processor is further configured to store a second table that associates the genre of text to be generated, the question text including the plurality of question items relating to the business, and the template, and
wherein the processor selects the question text and the template corresponding to the genre of text to be generated by referring to the second table.

5. The information processing device according to claim 1,
wherein the processor selects the plurality of templates with different contents, and
wherein the processor generates the instruction texts in which the answers to the plurality of question items are input in the selected plurality of templates.

6. The information processing device according to claim 1,
wherein the processor inputs a number of documents to be generated to the instruction text.

7. The information processing device according to claim 1,
wherein the processor is further configured to publish a reply from the document generation model on internet, and
wherein the processor publishes the reply specified by a business operator on the internet.

8. The information processing device according to claim 7,
wherein the processor is further configured to generate images or hashtags related to the reply from the document generation model.

9. An information processing method performed by a computer, comprising:
selecting a template corresponding to a selected question item from a plurality of question items relating to a business, from a plurality of templates each indicating an instruction text for a document generation model;
generating an instruction text in which answers to the plurality of question items are input in the selected template; and
displaying a reply to the generated instruction text from the document generation model.

10. A non-transitory computer-readable recording medium storing a program causing a computer to execute processing of:
selecting a template corresponding to a selected question item from a plurality of question items relating to a business, from a plurality of templates each indicating an instruction text for a document generation model;
generating an instruction text in which answers to the plurality of question items are input in the selected template; and
displaying a reply to the generated instruction text from the document generation model.
